(19) United States
(12) Patent Application Publication
(10) Pub. No.: US 2024/0376776 A1
(43) Pub. Date: Nov. 14, 2024

(54) GATE CHAIN TIGHTENING MECHANISM

(71) Applicant: Yossi Afriat, Sylmar, CA (US)

(72) Inventor: Yossi Afriat, Sylmar, CA (US)

(21) Appl. No.: 18/196,780

(22) Filed: May 12, 2023

(51) Int. Cl. E06B 11/04; E05F 5/08; E05F 11/04; E06B 11/02

(52) U.S. Cl. CPC E06B 11/045; B66D 1/60; E05F 5/08; E05F 11/04; E06B 11/026; B66D 2700/0116

(57) ABSTRACT

A securing apparatus includes a housing, a shaft, a sprocket having teeth, a bracket having a tooth, and a torsional spring. One end of a chain is coupled with the apparatus and a rotation of the shaft wraps the chain around the shaft thereby tightening the shaft. The bracket engages the teeth of the sprocket and the torsional spring maintains said engagement. A rotation of the shaft causes the bracket tooth to engage another tooth of the sprocket teeth further wrapping the chain around the shaft thereby tightening the chain.

### COPYRIGHT

A portion of the disclosure of this patent document contains material which is subject to copyright protection. The owner has no objection to the facsimile reproduction by anyone of the patent disclosure, as it appears in the Patent and Trademark Office files or records, but otherwise reserves all copyright rights whatsoever.

### FIELD OF INVENTION

The present invention relates to a securing apparatus that may be used with gates, such as small residential gates to commercial industrial gates, including slide types. The apparatus comprises a housing, a shaft, a sprocket, a bracket and a torsional spring, said apparatus operate to receive one end of a chain and to wrap the chain around the shaft thereby tightening the chain.

### BACKGROUND

Gates of all types are used in residential and commercial settings. They commonly utilize a gate operator which drives a chain which, in turn, slides the gate back and forth. Often, the initial length of the chain has to be adjusted to fit the length of the gate. In addition, over time, the chain's length increases due to tensioning and thus the chain sags requiring tightening in order to function properly. Therefore, there is a need for a chain tightening apparatus.

### SUMMARY

In one aspect, a securing apparatus is disclosed wherein the apparatus comprises a housing, a shaft rotatably coupled with the housing, said shaft comprising a first shaft-hole operative to receive a first end of a chain, a sprocket fixedly coupled with the shaft, said sprocket comprising sprocket teeth, a bracket pivotably coupled with the housing via a rod, said bracket comprising a bracket tooth operative to engage one of the sprocket teeth, and a torsional spring disposed around the rod, said torsional spring comprising a first end in contact with the housing and exerting a force on the housing and a second end in contact with the bracket and exerting the force on the bracket, said force operative to pivot the bracket around an axial axis of the rod thereby maintaining said engagement between the bracket tooth and the sprocket teeth, wherein a rotation of the shaft causes the bracket tooth to engage another tooth of the sprocket teeth, and wherein the rotation of the shaft further wraps the chain around the shaft thereby tightening the chain.

Preferably, the housing comprises a first housing-hole through a first side wall of the housing and a second housing-hole through a second side wall of the housing and wherein the shaft is inserted through the first housing-hole and the second housing-hole.

Preferably, the housing comprises a first housing-hole through a first side wall of the housing and a second housing-hole through a second side wall of the housing, wherein the bracket comprises a first bracket-hole through a first side wall of the bracket and a second bracket-hole through a second side wall of the bracket, and wherein the rod is inserted through the first housing-hole, the second housing-hole, the first bracket-hole and the second bracket-hole.

Preferably, the shaft comprises a first groove along an axial axis of the shaft and a second groove along the axial axis of the shaft, said second groove is disposed diametrically on the opposite side of the first groove, wherein the sprocket has a first sprocket-protrusion along an axial axis of the sprocket and a second sprocket-protrusion along the axial axis of the sprocket, said second sprocket-protrusion is disposed diametrically on the opposite side of the first sprocket-protrusion, and wherein the first sprocket-protrusion is seated in the first groove and the second sprocket-protrusion is seated in the second groove thereby causing the bracket to fixedly rotate with the shaft.

Preferably, the apparatus further comprises a spacer fixedly coupled with the shaft, said spacer comprising a first spacer-protrusion and a second spacer-protrusion, said second spacer-protrusion is disposed diametrically on the opposite side of the first spacer-protrusion, wherein the first spacer-protrusion is seated in the first groove and the second spacer-protrusion is seated in the second groove thereby causing the spacer to fixedly rotate with the shaft, and a pin, wherein the shaft further comprises a second shaft-hole, and wherein the pin is inserted into the second shaft-hole thereby preventing the shaft from decoupling from the housing.

Preferably, the apparatus further comprises a handle, wherein the shaft further comprises a third shaft-hole, and wherein the handle is inserted into the third shaft-hole to rotate the shaft.

Preferably, the sprocket teeth and the bracket tooth are beveled.

Preferably, a gate comprises the securing apparatus.

In another aspect, a securing apparatus is disclosed wherein the apparatus comprises a housing, a shaft rotatably coupled with the housing, said shaft comprising a first shaft-hole operative to receive a first end of a chain, a first means for providing teeth, said first means is fixedly coupled with the shaft, a second means for engaging one of the teeth of the first means, said second means is pivotably coupled with the housing, and a third means for exerting a force on the second means to pivot the second means thereby maintaining said engagement between the second means and the one of the teeth of the first means, wherein a rotation of the shaft causes the second means to engage another tooth of the first means, and wherein the rotation of the shaft further wraps the chain around the shaft thereby tightening the chain.

Preferably, the apparatus further comprises a spacer fixedly coupled with the shaft, and a fourth means for preventing the shaft from decoupling from the housing.

Preferably, the apparatus further comprises a fifth means for rotating the shaft, said fifth means is coupled with the shaft.

In another aspect, a method of tightening a chain is disclosed wherein the method comprises providing a housing, providing a shaft rotatably coupled with the housing, said shaft comprising a first shaft-hole operative to receive a first end of a chain, providing a sprocket fixedly coupled with the shaft, said sprocket comprising sprocket teeth, providing a bracket pivotably coupled with the housing via a rod, said bracket comprising a bracket tooth operative to engage one of the sprocket teeth, and providing a torsional spring disposed around the rod, said torsional spring comprising a first end in contact with the housing and exerting a force on the housing and a second end in contact with the bracket and exerting the force on the bracket, said force operative to pivot the bracket around an axial axis of the rod thereby maintaining said engagement between the bracket tooth and the sprocket teeth, wherein a rotation of the shaft causes the bracket tooth to engage another tooth of the sprocket teeth, and wherein the rotation of the shaft further wraps the chain around the shaft thereby tightening the chain.

Preferably, the housing comprises a first housing-hole through a first side wall of the housing and a second housing-hole through a second side wall of the housing and wherein the shaft is inserted through the first housing-hole and the second housing-hole.

Preferably, the housing comprises a first housing-hole through a first side wall of the housing and a second housing-hole through a second side wall of the housing, wherein the bracket comprises a first bracket-hole through a first side wall of the bracket and a second bracket-hole through a second side wall of the bracket, and wherein the rod is inserted through the first housing-hole, the second housing-hole, the first bracket-hole and the second bracket-hole.

Preferably, the shaft comprises a first groove along an axial axis of the shaft and a second groove along the axial axis of the shaft, said second groove is disposed diametrically on the opposite side of the first groove, wherein the sprocket has a first sprocket-protrusion along an axial axis of the sprocket and a second sprocket-protrusion along the axial axis of the sprocket, said second sprocket-protrusion is disposed diametrically on the opposite side of the first sprocket-protrusion, and wherein the first sprocket-protrusion is seated in the first groove and the second sprocket-protrusion is seated in the second groove thereby causing the bracket to fixedly rotate with the shaft.

Preferably, the method further comprises providing a spacer fixedly coupled with the shaft, said spacer comprising a first spacer-protrusion and a second spacer-protrusion, said second spacer-protrusion is disposed diametrically on the opposite side of the first spacer-protrusion, wherein the first spacer-protrusion is seated in the first groove and the second spacer-protrusion is seated in the second groove thereby causing the spacer to fixedly rotate with the shaft, and providing a pin, wherein the shaft further comprises a second shaft-hole, and wherein the pin is inserted into the second shaft-hole thereby preventing the shaft from decoupling from the housing.

Preferably, the method further comprises providing a handle, wherein the shaft further comprises a third shaft-hole, and wherein the handle is inserted into the third shaft-hole to rotate the shaft.

Preferably, the sprocket teeth and the bracket tooth are beveled.

Preferably, a method of providing a gate comprises the method of tightening a chain.

### DESCRIPTION OF THE DRAWINGS

FIG. 1 shows a perspective view of a gate system comprising a securing apparatus according to a preferred embodiment. The gate operator drives a chain which causes the gate to slide on a rail thereby opening and closing the gate. The securing apparatus is utilized during the installation to adjust the length of the chain. In addition, the securing apparatus is further utilized to tighten the chain because, over time, the chain's length increases due to tensioning and thus the chain sags requiring tightening in order to function properly.

FIG. 2 shows a perspective view of a gate system comprising a securing apparatus according to a preferred embodiment. A person may adjust/tighten the chain utilizing the securing apparatus.

FIG. 3 shows a perspective view of a securing apparatus according to a preferred embodiment, further showing how it may be connected to the gate.

FIG. 4 shows an exploded view of a securing apparatus according to a preferred embodiment.

FIG. 5 shows a perspective view of a housing of a securing apparatus according to a preferred embodiment.

FIG. 6 shows a perspective view of a bracket of a securing apparatus according to a preferred embodiment.

FIG. 7 shows a top view of a rod comprising a bolt, a tube, and a nut according to a preferred embodiment.

FIG. 8 shows a perspective view of a securing apparatus according to a preferred embodiment.

FIG. 9 shows a perspective view of a shaft of a securing apparatus according to a preferred embodiment.

FIG. 10 shows a perspective view of a sprocket of a securing apparatus according to a preferred embodiment.

FIG. 11 shows a perspective view of a spacer of a securing apparatus according to a preferred embodiment.

### DETAILED DESCRIPTION OF THE PRESENTLY PREFERRED EMBODIMENTS

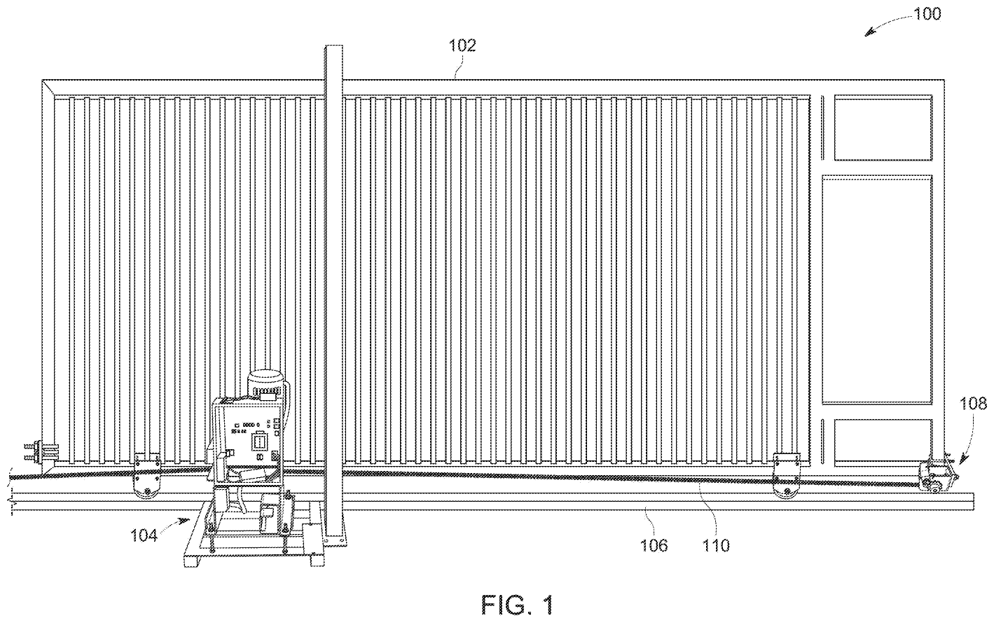

FIG. 1 depicts a perspective view of a gate system 100 comprising a securing apparatus 108 according to a preferred embodiment. The gate system 100 comprises a gate operator 104 which drives a chain 110 which in turn drives a gate 102 to slide on a rail 106 thereby opening and closing the gate. When installing the gate system 100, the chain 110 requires adjustment to its length so as to properly fit the length of the gate 102. The securing apparatus 108 may be used to adjust the length of the chain 110 in different applications. Furthermore, the length of the chain 110 increases over time making the chain 110 sag, thus causing the gate operator 104 to malfunction. By rotating a shaft of the securing apparatus 108 via a handle, the chain 110 wraps around the shaft thereby adjusting/tightening the chain 110.

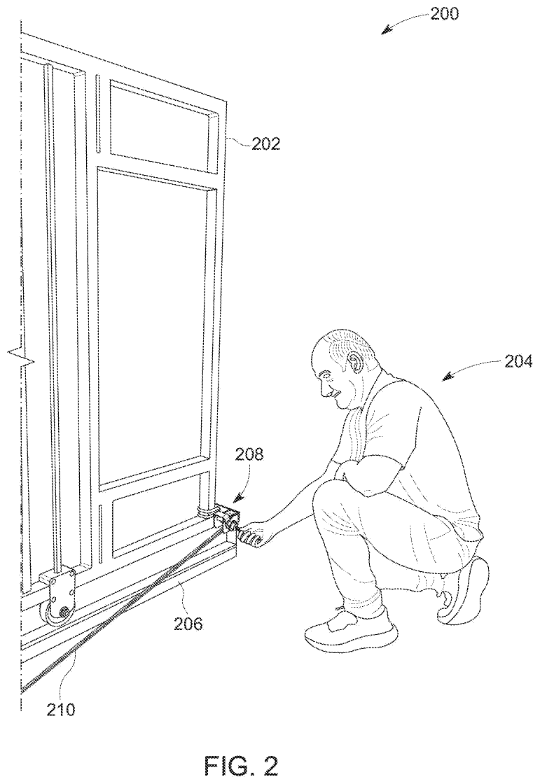

FIG. 2 depicts a perspective view of a gate system 200 comprising a securing apparatus 208 according to a preferred embodiment. The gate system 200 comprises a gate operator (not shown) which drives a chain 210 which in turn drives a gate 202 to slide on a rail 206 thereby opening and closing the gate. A person 204 may insert a handle into a shaft of the securing apparatus 208 to rotate the shaft to either adjust the length of the chain 210 or to further tighten the chain 210 after it sags due to repeated use. In an alternative embodiment, a motorized handle or a drive mechanism can be coupled with the shaft of the securing apparatus 208 to automatically adjust and/or tighten the length of the chain 210.

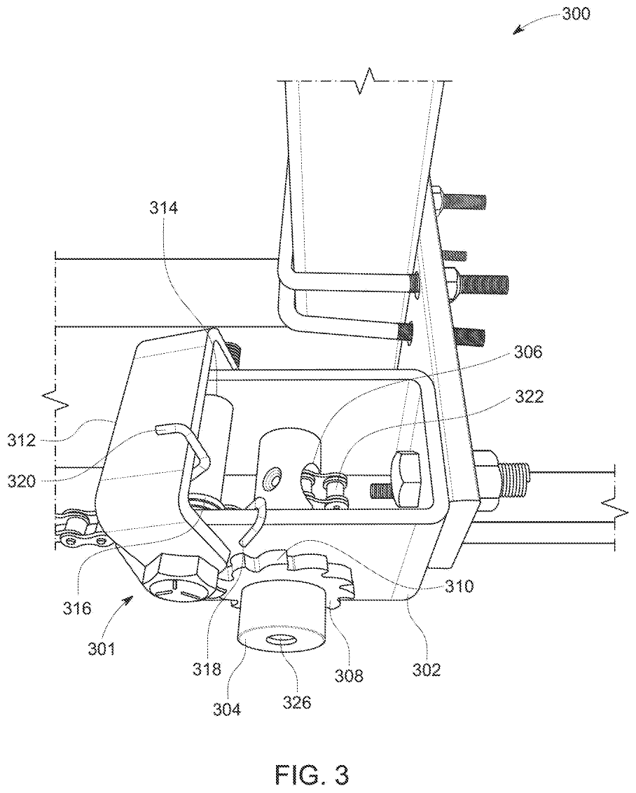

FIG. 3 shows a perspective view of a securing apparatus 301 according to a preferred embodiment. The securing apparatus 301 comprises a housing 302, a shaft 304, a sprocket 308, a bracket 312, and a torsional spring 316. The housing 302, the shaft 304, the sprocket 308, and the bracket 312 may be made from a variety of materials including metals such as steel or aluminum.

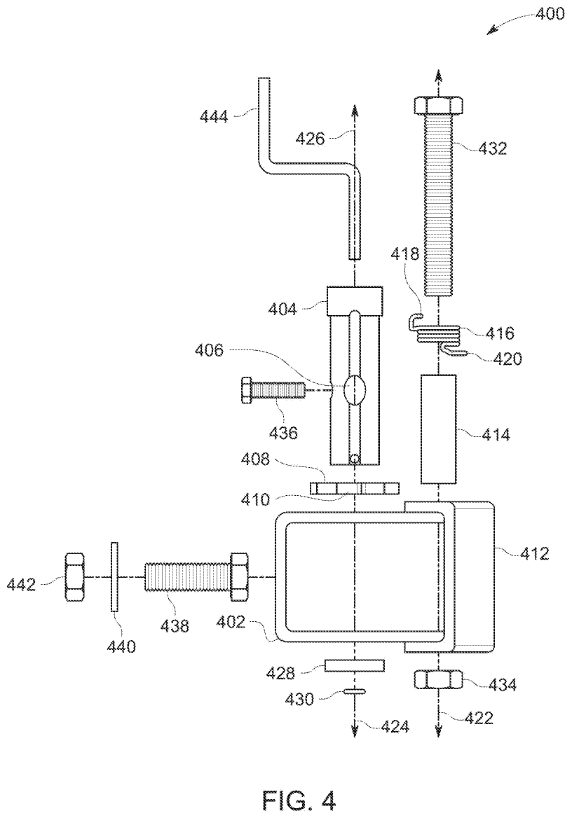

The shaft 304 is rotatably coupled with the housing 302 and includes a hole 306 which is operative to receive one end of a chain 322. Upon rotation of the shaft 304, the chain 322 is wrapped around the shaft 304. The shaft 304 may have another hole 326 where a handle (not shown in this figure but see FIG. 4) can be inserted into the hole 326 to rotate the shaft 304.

The sprocket 308 is fixedly coupled with the shaft 304 and comprises teeth 310. The teeth 310 of the sprocket 308 may have different geometries. In a preferred embodiment, the sprocket teeth 310 are beveled.

The bracket 312 is pivotably coupled with the housing 302 via a rod 314. In one preferred embodiment, the rod 314 is an assembly comprising a bolt, a tube, and a nut shown in FIGS. 4 and 7. In an alternative embodiment, the rod 314 is a solid shaft which can be coupled with the bracket 312 utilizing two bearings housed within the bracket 312. The bracket 312 comprises a tooth (not seen in this figure but see FIG. 6) that engages one of the teeth 310 of the sprocket 308.

The torsional spring 316 is disposed around the rod 314 and comprises a first end 318 and a second end 320. The first end 318 is in contact with the housing 302 and the second end 320 is in contact with the bracket 312.

Under a pre-load, the first end 318 exerts a force on the housing 302 and the second end exerts the force on the bracket 312. The force operates to pivot the bracket 312 around an axial axis of the rod 314 thereby maintaining the engagement between the bracket tooth and the sprocket teeth 310. A rotation of the shaft 304 causes the bracket tooth to engage another tooth of the sprocket teeth 310 and to further wrap the chain 322 around the shaft 304 thereby tightening the chain 322.

FIG. 4 depicts an exploded view of a securing device 400 according to a preferred embodiment. The securing apparatus 400 comprises a housing 402, a shaft 404, a sprocket 408, a bracket 412, and a torsional spring 416. In this preferred embodiment, the securing apparatus further comprises a spacer 428, a pin 430, and a handle 444. The housing 402 can be secured to a plate and subsequently to a gate via a bolt 438, a washer 440, and a nut 442.

The shaft 404 can be rotatably coupled with the housing 402 and includes a hole 406 which is operative to receive one end of a chain, such as the chain 322 in FIG. 3. A bolt 436 is utilized to secure the chain 322 to the shaft 404 via a side threaded hole of the shaft 404. The shaft 404 has another blind hole (not visible in this view but see the hole 326 in FIG. 3) where the handle 444 can be inserted into the blind hole to rotate the shaft 404 about its axial axis 426.

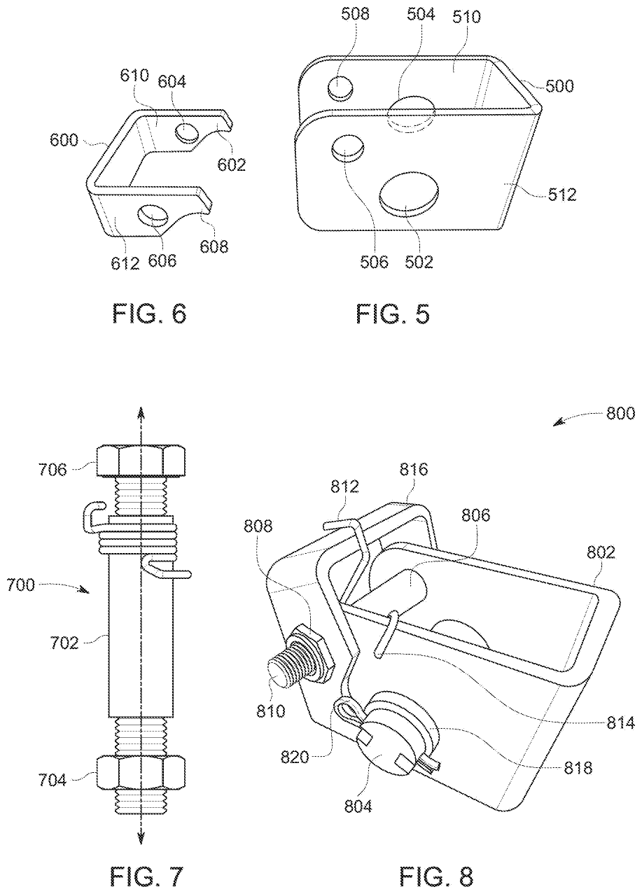

The sprocket 408 is fixedly coupled with the shaft 404 and comprises teeth 410. The sprocket 408 has two protrusions (not visible in this view but see FIG. 10) which are disposed diametrically on opposite side of each other and are seated in two grooves of the shaft 404 so that the sprocket 408 rotates fixedly with the shaft 404. The two grooves of the shaft 404 run along an axial axis of the shaft 404 (see FIG. 5) and are disposed diametrically on opposite side of each other to receive the two protrusions of the sprocket 408.

The bracket 412 is pivotably coupled with the housing 402 via a rod which in this preferred embodiment is an assembly comprising a bolt 432, a tube 414, and a nut 422. The bracket 412 comprises a tooth (not seen in this figure but see FIG. 6) that engages one of the teeth 410 of the sprocket 408.

The torsional spring 416 is disposed around the tube 414 and comprises a first end 418 and a second end 420. The first end 418 is in contact with the housing 402 and the second end 420 is in contact with the bracket 412.

FIG. 5 depicts a perspective view of a housing 500 of a securing apparatus, such as the securing apparatus 300 or 400 of FIGS. 3 and 4, according to a preferred embodiment. The housing 500 comprises a hole 502, a hole 504, a hole 506, and a hole 508. The hole 502 and the hole 506 are drilled through a side wall 512 of the housing 500. The hole 504 and the hole 508 are drilled through a side wall 510 of the housing 500.

FIG. 6 depicts a perspective view of a bracket 600 of a securing apparatus, such as the securing apparatus 300 or 400 of FIGS. 3 and 4, according to a preferred embodiment. The bracket 600 comprises a hole 604 and a hole 606. The hole 604 is drilled through a side wall 610 of the bracket 600 and the hole 606 is drilled through a side wall 612 of the bracket 600. The bracket 600 includes a tooth 602 and another tooth 608. Although in this embodiment the bracket 600 has two teeth, only one of the teeth 602 and 608 is required to engage the teeth of a sprocket, such as the teeth 310 and 410 of sprockets 308 and 408 shown in FIGS. 3 and 4.

FIG. 7 depicts a top view of a rod assembly 700 comprising a bolt 706, a tube 702, and a nut 704 according to a preferred embodiment. An unloaded torsional spring is shown in this figure for illustrative purposes. As described above, the rod assembly 700 can be a solid shaft that is inserted through the bracket holes, such as the holes 604 and 606 of FIG. 6 and the housing holes, such as the holes 506 and 508 of FIG. 5. Two bearings can be housed in the holes 604 and 605 and the solid shaft is seated within the inner races of the bearings, thereby, allowing the bracket, such as the bracket 600 of FIG. 6, to pivot about the axial axis of the shaft.

FIG. 8 depicts a perspective view of a securing apparatus 800 according to a preferred embodiment. The securing apparatus 800 further includes a spacer 818 and a pin 820. As described above in connection with FIGS. 3-7, the securing apparatus 800 includes a housing 802, a shaft 804, a sprocket (not visible in this view), a bracket 816, a rod 806, and a torsional spring having a first end 814 and a second end 814. The pin 820 is inserted into the hole (see FIG. 5) to prevent the shaft 804 from decoupling from the housing 802.

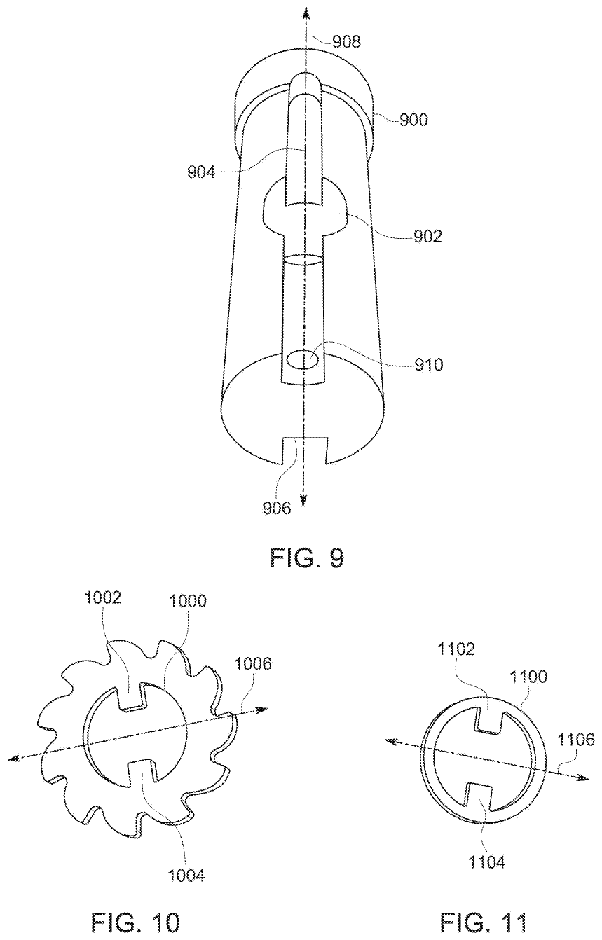

FIG. 9 depicts a perspective view of a shaft 900 of a securing apparatus, such as the securing apparatus 300 or 400 of FIGS. 3 and 4, according to a preferred embodiment. The shaft 900 can be rotated about its axial axis 908. The shaft 900 comprises a hole 902 operative to receive one end of a chain such as the chain 322 shown in FIG. 3. The shaft 900 comprises a hole 910 where a pin, such as the pin 820 shown in FIG. 8 can be inserted to prevent decoupling of the shaft 900 from the housing 802. The shaft 900 comprises a groove 904 along its axial axis 908 and a groove 906 along the axial axis 908 and diametrically on the opposite side of the groove 906.

FIG. 10 depicts a perspective view of a sprocket 1000 of a securing apparatus, such as the securing apparatus 300 or 400 of FIGS. 3 and 4, according to a preferred embodiment. The sprocket 1000 comprises a protrusion 1002 along its axial axis 1006 and a protrusion 1004 along the axial axis 1006 and diametrically on the opposite side of the protrusion 1002. The protrusions 1002 and 1004 can be seated in the grooves 904 and 906 of the shaft 900 of FIG. 9.

FIG. 11 depicts a perspective view of a spacer 1100 of a securing apparatus, such as the securing apparatus 300 or 400 of FIGS. 3 and 4, according to a preferred embodiment. The spacer 1100 comprises a protrusion 1102 along its axial axis 1106 and a protrusion 1104 along the axial axis 1106 and diametrically on the opposite side of the protrusion 1102. The protrusions 1102 and 1104 can be seated in the grooves 904 and 906 of the shaft 900 of FIG. 9.

The foregoing explanations, descriptions, illustrations, examples, and discussions have been set forth to assist the reader with understanding this invention and further to demonstrate the utility and novelty of it and are by no means restrictive of the scope of the invention. It is the following claims, including all equivalents, which are intended to define the scope of this invention.

What is claimed is:

1. A securing apparatus, comprising:
(a) a housing;
(b) a shaft rotatably coupled with the housing, said shaft comprising a first shaft-hole operative to receive a first end of a chain;
(c) a sprocket fixedly coupled with the shaft, said sprocket comprising sprocket teeth;
(d) a bracket pivotably coupled with the housing via a rod, said bracket comprising a bracket tooth operative to engage one of the sprocket teeth; and
(e) a torsional spring disposed around the rod, said torsional spring comprising a first end in contact with the housing and exerting a force on the housing and a second end in contact with the bracket and exerting the force on the bracket, said force operative to pivot the bracket around an axial axis of the rod thereby maintaining said engagement between the bracket tooth and the sprocket teeth;
wherein a rotation of the shaft causes the bracket tooth to engage another tooth of the sprocket teeth, and
wherein the rotation of the shaft further wraps the chain around the shaft thereby tightening the chain.

2. The apparatus of claim 1, wherein the housing comprises a first housing-hole through a first side wall of the housing and a second housing-hole through a second side wall of the housing and wherein the shaft is inserted through the first housing-hole and the second housing-hole.

3. The apparatus of claim 1, wherein the housing comprises a first housing-hole through a first side wall of the housing and a second housing-hole through a second side wall of the housing, wherein the bracket comprises a first bracket-hole through a first side wall of the bracket and a second bracket-hole through a second side wall of the bracket, and wherein the rod is inserted through the first housing-hole, the second housing-hole, the first bracket-hole and the second bracket-hole.

4. The apparatus of claim 1, wherein the shaft comprises a first groove along an axial axis of the shaft and a second groove along the axial axis of the shaft, said second groove is disposed diametrically on the opposite side of the first groove, wherein the sprocket has a first sprocket-protrusion along an axial axis of the sprocket and a second sprocket-protrusion along the axial axis of the sprocket, said second sprocket-protrusion is disposed diametrically on the opposite side of the first sprocket-protrusion, and wherein the first sprocket-protrusion is seated in the first groove and the second sprocket-protrusion is seated in the second groove thereby causing the bracket to fixedly rotate with the shaft.

5. The apparatus of claim 4, further comprising:
(f) a spacer fixedly coupled with the shaft, said spacer comprising a first spacer-protrusion and a second spacer-protrusion, said second spacer-protrusion is disposed diametrically on the opposite side of the first spacer-protrusion, wherein the first spacer-protrusion is seated in the first groove and the second spacer-protrusion is seated in the second groove thereby causing the spacer to fixedly rotate with the shaft; and
(g) a pin;
wherein the shaft further comprises a second shaft-hole, and
wherein the pin is inserted into the second shaft-hole thereby preventing the shaft from decoupling from the housing.

6. The apparatus of claim 5, further comprising:
(h) a handle;
wherein the shaft further comprises a third shaft-hole, and
wherein the handle is inserted into the third shaft-hole to rotate the shaft.

7. The apparatus of claim 1, wherein the sprocket teeth and the bracket tooth are beveled.

8. A gate comprising the apparatus of claim 1.

9. A securing apparatus, comprising:
(a) a housing;
(b) a shaft rotatably coupled with the housing, said shaft comprising a first shaft-hole operative to receive a first end of a chain;
(c) a first means for providing teeth, said first means is fixedly coupled with the shaft;
(d) a second means for engaging one of the teeth of the first means, said second means is pivotably coupled with the housing; and
(e) a third means for exerting a force on the second means to pivot the second means thereby maintaining said engagement between the second means and the one of the teeth of the first means;
wherein a rotation of the shaft causes the second means to engage another tooth of the first means, and
wherein the rotation of the shaft further wraps the chain around the shaft thereby tightening the chain.

10. The apparatus of claim 9, further comprising:
(f) a spacer fixedly coupled with the shaft; and
(g) a fourth means for preventing the shaft from decoupling from the housing.

11. The apparatus of claim 10, further comprising:
(h) a fifth means for rotating the shaft, said fifth means is coupled with the shaft.

12. A method of tightening a chain, comprising:
(a) providing a housing;
(b) providing a shaft rotatably coupled with the housing, said shaft comprising a first shaft-hole operative to receive a first end of a chain;
(c) providing a sprocket fixedly coupled with the shaft, said sprocket comprising sprocket teeth;
(d) providing a bracket pivotably coupled with the housing via a rod, said bracket comprising a bracket tooth operative to engage one of the sprocket teeth; and
(e) providing a torsional spring disposed around the rod, said torsional spring comprising a first end in contact with the housing and exerting a force on the housing and a second end in contact with the bracket and exerting the force on the bracket, said force operative to pivot the bracket around an axial axis of the rod thereby maintaining said engagement between the bracket tooth and the sprocket teeth;
wherein a rotation of the shaft causes the bracket tooth to engage another tooth of the sprocket teeth, and
wherein the rotation of the shaft further wraps the chain around the shaft thereby tightening the chain.

13. The method of claim 12, wherein the housing comprises a first housing-hole through a first side wall of the housing and a second housing-hole through a second side wall of the housing and wherein the shaft is inserted through the first housing-hole and the second housing-hole.

14. The method of claim 12, wherein the housing comprises a first housing-hole through a first side wall of the housing and a second housing-hole through a second side wall of the housing, wherein the bracket comprises a first bracket-hole through a first side wall of the bracket and a second bracket-hole through a second side wall of the bracket, and wherein the rod is inserted through the first housing-hole, the second housing-hole, the first bracket-hole and the second bracket-hole.

15. The method of claim 12, wherein the shaft comprises a first groove along an axial axis of the shaft and a second groove along the axial axis of the shaft, said second groove is disposed diametrically on the opposite side of the first groove, wherein the sprocket has a first sprocket-protrusion along an axial axis of the sprocket and a second sprocket-protrusion along the axial axis of the sprocket, said second sprocket-protrusion is disposed diametrically on the opposite side of the first sprocket-protrusion, and wherein the first sprocket-protrusion is seated in the first groove and the second sprocket-protrusion is seated in the second groove thereby causing the bracket to fixedly rotate with the shaft.

16. The method of claim 15, further comprising:
(f) providing a spacer fixedly coupled with the shaft, said spacer comprising a first spacer-protrusion and a second spacer-protrusion, said second spacer-protrusion is disposed diametrically on the opposite side of the first spacer-protrusion, wherein the first spacer-protrusion is seated in the first groove and the second spacer-protrusion is seated in the second groove thereby causing the spacer to fixedly rotate with the shaft; and
(g) providing a pin;
wherein the shaft further comprises a second shaft-hole, and
wherein the pin is inserted into the second shaft-hole thereby preventing the shaft from decoupling from the housing.

17. The method of claim 16, further comprising:
(h) providing a handle;
wherein the shaft further comprises a third shaft-hole, and
wherein the handle is inserted into the third shaft-hole to rotate the shaft.

18. The method of claim 12, wherein the sprocket teeth and the bracket tooth are beveled.

19. A method of providing a gate comprising the method of claim 12.
